(19) United States
(12) Patent Application Publication
(10) Pub. No.: US 2016/0338537 A1
(43) Pub. Date: Nov. 24, 2016

(54) Outdoor Food Warming Apparatus

(71) Applicant: Jeffrey D. Holt, Huntsville, UT (US)

(72) Inventor: Jeffrey D. Holt, Huntsville, UT (US)

(21) Appl. No.: 15/160,446

(22) Filed: May 20, 2016

Related U.S. Application Data
(60) Provisional application No. 62/164,731, filed on May 21, 2015.

(51) Int. Cl. A47J 37/07; A47J 33/00

(52) U.S. Cl. CPC A47J 37/0786; A47J 33/00; A47J 2037/0777

(57) ABSTRACT

A food warming apparatus for use with an open outdoor campfire or fire pit, the apparatus comprising a substantially vertical heat collection element shaped to act as a substantially vertical support element connected with a substantially horizontal warming tray element having openings to dissipate heat and provide temperature variability across the surface of the warming tray. The substantially vertical support element is of a curved panel shape extending upward from the ground and serving to both shield a user from a fire as well as conduct heat upwards from a fire to the warming tray and food or food containers placed thereon. The apparatus is made of a fire resistant, durable, and at least partially conductive material such as metal. Embodiments include those made for larger family size fire circles as well as small lightweight and foldable embodiment suitable for transport and camping.

### CROSS-REFERENCE TO RELATED APPLICATIONS

The present non-provisional application claims the benefit of a commonly assigned provisional application having Ser. No. 62/164,731, filed on May 21, 2015 and entitled Food Warming Apparatus and Method, which application is incorporated herein by reference in its entirety.

### BACKGROUND OF THE INVENTION

1. Field of the Invention

The present invention relates in general to outdoor heating equipment and in particular relates to a food warmer for use with an open fire or outdoor fire pit.

2. Discussion of the State of the Art

A variety of warming devices have been designed for use with open fires or outdoor fire pits. Many such devices incorporate a base element which shields the fire from the user or otherwise provide a wind protected bowl or space to build the fire. Some prior art designs incorporate vertically adjustable standards or arms that may be attached with a grate, grill or other substantially horizontal heating elements designed to hold pots, pans, or foods items over open flame.

There are a number of problems associated with such prior art designs. One problem is that they are often not designed for use with existing fire spaces or pits. They are generally stand-alone designs built to either house an open fire in a bowl or other predefined space (such as a covered box) or are otherwise not adaptable for use on uneven ground or existing ceramic or rock circle pits. Another problem with prior art designs is that the food warming element (such as a grate, grill, shelf or tray) is designed to extend out over the fire thus requiring the user to reach out (using an arm, poker or extension device) over the open flame, smoke or high temperature to place or remove items from the food warming element. If the user is interested in adjusting the heat reaching the warming element, he/she must adjust the standard to raise or lower the horizontal element or swivel the horizontal element so that it is moved away from the open flame. Another problem is that prior art designs are generally not portable but are instead large heavy assemblies built to support fuel for the fire as well as hold the horizontal warming element over open flame or coals and thus they cannot be easily packed away or transported in a vehicle if desired. Another problem is that the horizontal warming elements of the prior art are uniform in design and conductivity such that, while in use over an open flame or coals, the heat is conducted relatively uniformly to the edges of the warming element. This means that a cup place on the edge of a horizontal warming element of a prior art design will heat up almost as quickly as a cup placed at or near the center of the warming element.

A specific example of a prior art designs having most of the problems discussed above is the Modular Fire Pit Table (first inventor Sunil Kumar Dhuper) described in US2013/0081609. The invention described includes a table apparatus having a fire bowl and warming (called “hot top”) member having a horizontal planar surface on which one or more objects can be placed, wherein the fire bowl and the hot top member are rotatably coupled to the table apparatus to permit rotation of the fire bowl relative to the warming table. The invention is essentially a large, stand alone, fire bowl and table apparatus that is not particularly mobile and not for use with existing fire pits or bowls. While the apparatus allows the user to place food items on the hot top portion on a variety of discreet heat conductive and non-conductive surfaces for warming, the overall apparatus is overly complex, difficult to manage, and expensive to manufacturer. It is certainly not something that can be easily folded up and placed in a garage or moved easily.

Another specific example of a prior art design having most of the problems discussed above is the Camping Furnace (inventor J. R. Whitted) described in U.S. Pat. No. 5,682,872. The invention described is an apparatus used for cooking or warming food outdoors. A tube-like base element surrounds the burning fuel and directs smoke upward. A grate may be attached horizontally over the top of the tube to allow food, pots, pans and other things to be placed thereon and over the fire. The invention (including the tube itself) may be assembled, disassembled and carried, and it can be used with existing fire pits though probably not very effectively on surfaces (such as rocks) which are sloped or not necessarily even. An additional drawback is the attachable grate which sits directly over the fire. In some embodiments, the grate may extend out over the edges of the tube, but the grate is not designed to be particularly conductive and the invention relies on the extension of the warming grate over the fire. Also, the tube completely surrounds the fire thus substantially blocking the fire from view.

Another specific example of a prior art invention having the problems discussed above is the Fire Ring (first inventor David C. Young) described in U.S. Pat. No. 5,329,917. The invention described is a portable fire ring with grill extension and pivotal grill which extends over the grill extension. Attachments to the ring including a pivotal support for holding a container of water or other liquid over the fire as well as extending arms for supporting a pot or other container over the fire. Though designed to be disassembled and carried in a case, the apparatus is large, heavy and not moved easily. It may accommodate a variety of fire pit areas, though it is not easily used with existing ceramic (i.e. brick) or rock circles which do not match the diameter of the fire ring apparatus and the grate extension (which extends from the ring) would not be usable unless the fire ring diameter is larger than the existing ceramic or rock fire circle. Further, the prior art inventions (including the Young invention) mentioned above require heating (or tray) element to be swiveled over an open fire thus requiring additional cleaning of soot from the tray.

What is needed is a food warming apparatus adapted for use with an open fire which does not present the problems of the prior art.

### BRIEF SUMMARY OF THE INVENTION

The invention described herein is a food warming apparatus for use with an open outdoor fire or fire pit, the apparatus comprising a substantially vertical support element connected with a substantially horizontal warming tray element. The support element is made of a fire resistant heat conductive material such as steel, iron, copper or the like. The warming tray element is made of similarly conductive fire resistant and heat conductive material and is sized for placing food items or containers containing food items to be warmed thereon. The combination of support and tray elements differs substantially from the prior art in that the combination is configured such that the warming tray extends substantially away from the fire rather than over the fire and the heat is translated to the tray (and ultimately to the food placed thereon) by the conduction of heat through the support element to the warming tray element. In contrast, prior art assemblies are configured such that the food is heated by a tray which extends from the support over open flame or coals.

In one embodiment, the substantially vertical support element is of a curved panel shape extending upward from the ground and serving to both shield a user from a fire as well as conduct heat upwards from a fire to the substantially horizontal warming tray element. In its preferred embodiment, the support is approximately 38″ at the bottom and top edges and approximately 18″ at the side edges and curved to easily accommodate a standard 44″ diameter fire pit circle. The support element only abuts a portion of the fire and therefore does not entirely obscure the fire from view. Further, the vertical support element act as a layer of protection between the fire and the fire ring.

In one embodiment, the substantially horizontal warming tray element is connected with the top edge of the support element extending away from the fire or fire pit. In its preferred embodiment, the warming tray element is trapezoidal or fan shaped with an inside edge of approximately 16″ extending outward to a curved outside edge of approximately 25″ with flaring side edges of approximately 10¾″ inches. One portion of the warming tray element has holes or grates to slow down the conduction of heat towards one or more outside corners or edges.

The warming tray element may be connected with the support element in a variety of ways. In a preferred embodiment, the tray element is welded to the upper edge of the support element with the inside edge of the tray extending 1-3 inches inward to provide a straight edge lip. In alternative embodiments, the warming tray element is connected with a hinge allowing the tray to fold against the support when not in use or is connected using detachable mechanical means. In alternative embodiments, the entire assembly is foldable and portable. A variety of configurations and sizes are consistent with the principles of the invention including a small lightweight and foldable embodiment suitable for camping.

### BRIEF DESCRIPTION OF THE SEVERAL VIEWS OF THE DRAWINGS

FIG. 1 is a top perspective view of an embodiment of the food warming apparatus consistent with the principles of the invention.

FIG. 2A is a top perspective view of the embodiment of the food warming apparatus shown in FIG. 1 consistent with the principles of the invention.

FIG. 2B is a bottom perspective view of the embodiment of the food warming apparatus shown in FIG. 1 consistent with the principles of the invention.

FIG. 3 is a perspective view of an embodiment of the food warming apparatus consistent with the principles of the invention placed within a fire pit and adjacent to an open fire.

FIG. 4A is a front side perspective view of an embodiment of the food warming apparatus consistent with the principles of the invention.

FIG. 4B is a back side perspective view of an embodiment of the food warming apparatus consistent with the principles of the invention.

FIG. 5A is a left side perspective view of an embodiment of the food warming apparatus consistent with the principles of the invention.

FIG. 5B is a right side perspective view of the embodiment of the food warming apparatus shown in FIG. 5a.

FIG. 6 is a front side perspective view of an embodiment of the food warming apparatus consistent with the principles of the invention.

FIG. 7 is a back side perspective view of an embodiment of the food warming apparatus consistent with the principles of the invention.

FIG. 8 is a side perspective view of an embodiment of the food warming apparatus consistent with the principles of the invention.

FIG. 9 is a photograph showing a bottom perspective view of an embodiment of the food warming apparatus consistent with the principles of the invention.

FIG. 10 is a photograph showing a bottom perspective view of an embodiment of the food warming apparatus consistent with the principles of the invention.

### DETAILED DESCRIPTION OF THE INVENTION

In various embodiments described in enabling detail herein, the inventor provides a unique apparatus and method that enables users to warm food outdoors with an open flame in a manner not requiring the user to reach out over the open flame or otherwise adjust a pot or arm extending over an open flame. The invention also allows the user to adjustably warm food adjacent an open flame while remaining protected from the flame and smoke. The present invention is described using the following examples, which may describe more than one relevant embodiment falling within the scope of the invention.

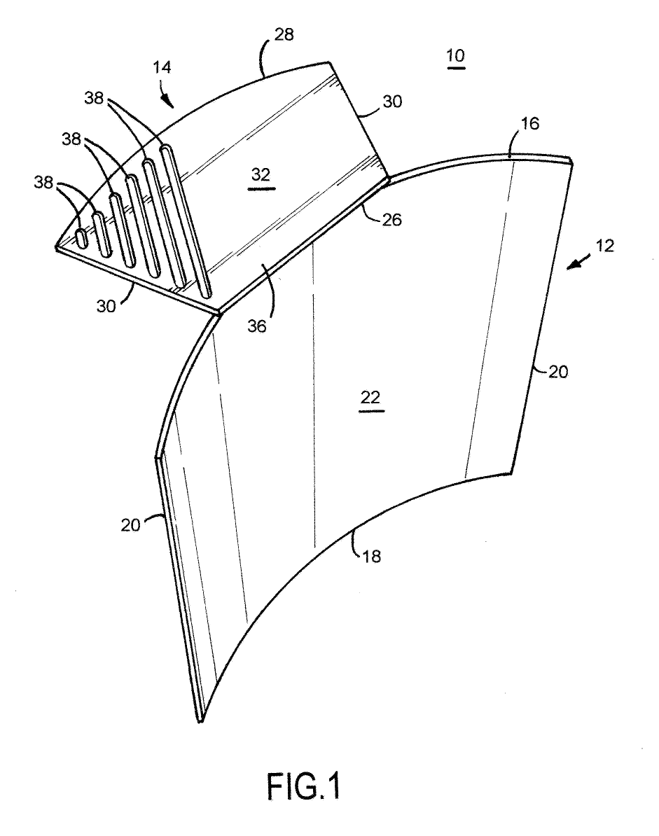

FIG. 1 is a top perspective view of a preferred embodiment of the food warming apparatus consistent with the principles of the present invention. The warming apparatus 10 comprises a substantially vertically extending support element 12 connected with a substantially horizontally extending warming tray element 14.

The embodiment of the support element 12 shown is configured as a planar arc having equally sized top 16 and bottom 18 edges as well as equally sized side 20 edges. The inside surface 22 of the support element is the concave surface that will be positioned adjacent to an open fire (or other heat source). The outside surface 24 (not shown) of the support element is the convex surface that extends away from the fire.

The embodiment of the substantially horizontal warming tray 14 shown is configured as a trapezoid or fan shape having a substantially straight inside edge 26, a curved outside edge 28, two side edges 30, a top surface 32 and a bottom surface 34. As the outside edge 28 is longer than the inside edge 26, the two side edges 30 flare outward as they extend away from the support element.

As shown in FIG. 1, the warming tray element 14 is connected with the support element 12 such that the majority of the warming tray 14 extends outward or away from the inside surface 22 of the support element and, thus, away from the fire. The inside edge 26 of the warming tray element extends over the inside surface 22 of the support element 12 (approximately 2-3″ as shown) creating what may be described as an inside lip 36 which may be warmed by open fire or coals.

The warming tray 14 element is substantially flat and solid except for the openings 38 which serve to dissipate the conducted heat at one edge of the tray element 14. These openings are optional although they are included in the embodiment shown in FIG. 1 so that different portion of the warming tray 14 will conduct different amounts of heat to the food placed thereon. As such, the user may wish to place food that she wants to be hottest closest to the inside edge 16 and food that she wants to be less hot on those portions of the warming tray 14 having openings 38 with those portions of the warming tray having openings 38 closest to the outside edge 28 of the warming tray 14 being likely to conduct less heat to the food than those portions with openings 38 closer to the inside edge 26 and those portions having openings 38 being likely to conduct less heat to the food than those portions not having openings 38. In alternative embodiments consistent with the invention, there may be no openings, openings of different sizes or shapes, and/or openings that vary along the surface of the tray element 14. For example, an alternative embodiment of the invention might have circular opening of uniform size extending entirely along the outside edge 28 or one or more side edges 30 of the warming tray element. Alternatively, the openings may include grates, mesh or other methods of holding food items while allowing air and heat to pass through the surface of the warming tray element.

The support element 12 and tray element 14 of the apparatus are made of durable, heat resistant, heat conductive material such as iron, steel, copper, aluminum, other metals and/or materials (such rock or ceramics) which are generally used with open fire pits. The size of the apparatus can vary substantially depending on the desired mobility and use. For example, an apparatus which is intended to be used in a large family size fire pit and will not be moved constantly may have a support element 12 which extends approximately 18″ from the bottom edge 18 to the top edge 16 and extend approximately 35″ from one side edge to the other. The corresponding warming tray element 14 will have an inside edge 26 of approximately 16″, and an outside edge 28 of approximately 25″. Both the support element 12 and the tray element 14 may be made of iron, steel or other conductive material that is generally ½″ in thickness although the invention accommodates different thicknesses depending on the material being used. For example, an embodiment made of copper may be made of a thickness that is less than steel because copper tends to conduct heat more easily than steel. The measurements provided above are used for the embodiment shown in FIG. 1. However, alternative embodiments may be much smaller in size to be used with a smaller sized fire, or backpacker's cooking stove. As one familiar with the art will easily appreciate, the approximately dimensions of such alternative embodiment will be adjusted depending on the size of the fire that it is intended to be used with, the type of material it is made of, the intended mobility of the apparatus and other factors such as the preference of the user, the intended cost of the apparatus etc.

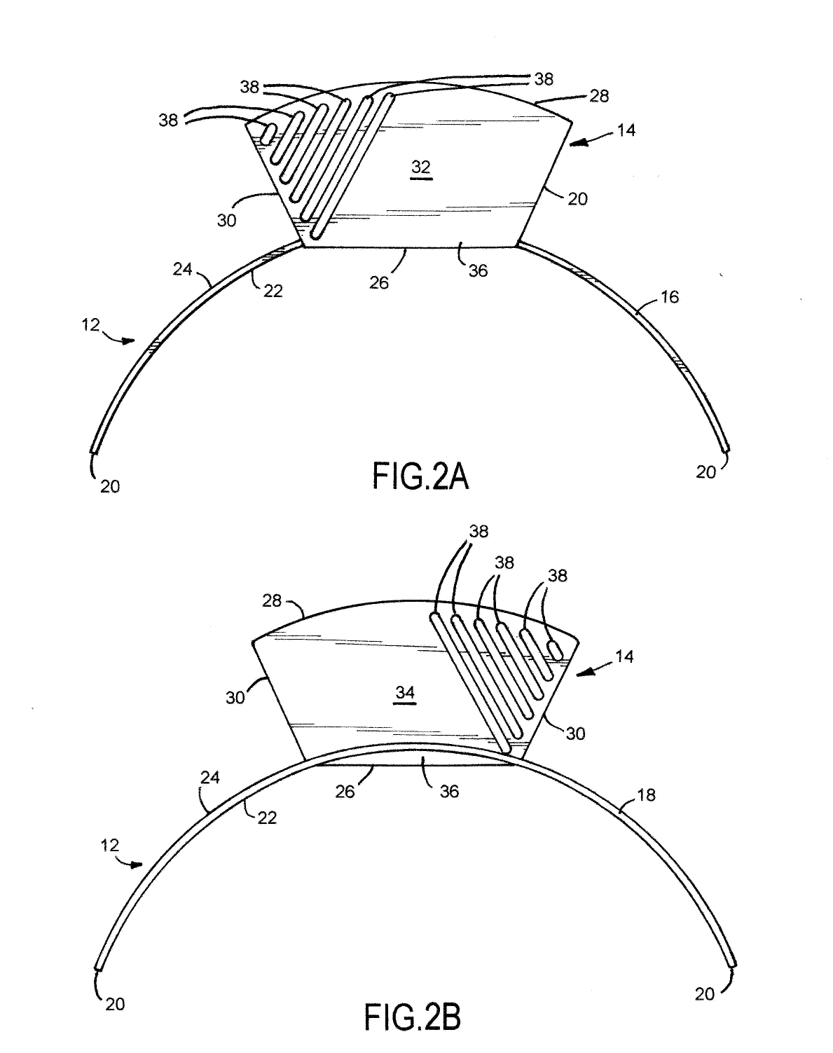

FIG. 2A is a top perspective view of the preferred embodiment of the food warmer apparatus 10. As shown the bottom surface horizontal warming tray 14 element is connected with vertical support element 12 at the center top edge 16 of the support element. In alternative embodiments, the warming tray 14 may be connected with the support element at other locations along the top edge 16. Alternatively, the warming tray element may be connected with the support element below the top edge 16 of the support element. The outside surface 24 of the support element 12 is shown. One will note that the lip 36 of the tray element 14 extends out over the inside surface 22 and, in this embodiment, the lip has a straight edge. In alternative embodiments, there may be no lip with the tray element stopping at the top edge 16 of the support element 12. In one embodiment, the lip 36 of the tray element 14 may extend further out over the inside surface 22 forming a half circle, rectangle, square, trapezoidal or other shape. Further, in alternative embodiments the lip 36 may extend upward and away from the top edge 16 of the support element 12 to create a raised lip thus preventing food from sliding out over the inside edge 26. In alternative embodiments, the inside edge 26 may be turned upward in a 90 degree angle from the op surface 32 creating a vertical edge and thus shielding the top surface 32 from flame, wind, or smoke.

FIG. 2B is a bottom perspective view of the preferred embodiment of the food warming apparatus. Both the bottom edge 18 of the support element and bottom surface 34 of the warming tray 14 element are visible. In this embodiment, the top edge 16 of the support element 12 is attached directly with the bottom surface 34 of the warming tray element such that the inside edge 26 of the warming tray extends outward from the inside surface 22 of the support element 12 defining a lip 36 which would extend toward the fire placed adjacent to the inside surface 22 of the support element when in use. Again, alternative embodiments may have a lip which stops at the top edge 16 of the support element or which extends further out over the inside surface 22, or otherwise extends into a shape which (circular, square, rectangular, trapezoidal etc.) which is different than that shown in FIG. 2B.

With regard to the connection of the warming tray 14 element with the support element 12, a number of alternative options are contemplated by the invention. In one embodiment for use with a family sized fire pit, the warming tray element 14 is welded to the support element 12. Alternative embodiments might include a hinged connection with locking mechanism allowing the substantially horizontal warming tray element 14 to be folded downward toward the outside surface 24 of the support element 12 when closed and supported in horizontal positon relative to the support element when the tray is in use. Alternative embodiments using other materials, such as ceramics, the support element may be molded with the warming tray element. In one embodiment, the warming tray element is detachable from the support element and is supported in connection with the support element using detachable means (such as hooks or other support mechanism known in the art). In another embodiment an elongated slot in the support element would allow the insertion, secured connection with, and removal of a correspondingly configured warming tray element from the support element. For example, a horizontal slot may be cut into the support element at a location approximately 3-4″ from the top edge 16 of the support element at a width and length sufficient to insert the inside edge 26 of the warming tray 14 element such that the inside edge will extend over the inside surface 22 of the support element and allow the warming tray to remain supported in the slot and extending from the support element without use of fasteners or locking members and, after use and cooling, removed from the support element.

It should be noted that the embodiment shown in FIGS. 1, 2A and 2B show the openings 38 extending through the entire thickness of the support tray 14. In alternative embodiments, the openings 38 may be replaced by indentations which extend partially through to allow a gap between the food placed on the top of the tray element 14 and the top surface 32 of the tray element 14. In alternative embodiments the openings 38 could be made in the shape of a circle which would accommodate partial insertion of a coffee cup, mug or other drinking vessel that is intended to be placed on the tray 14 and warmed. In alternative embodiments, the top surface of the tray 14 element would have indentations that would accommodate the placement of drinking vessels, trays, plates, pans or other food containers. In alternative embodiments, there may be raised portions (such as, for example, raised circular bumps or ridges) extending upward from the top surface of the warming element 14 which may serve to either dissipate heat from food of food containers placed thereon or otherwise hold a cup, plate or other food container.

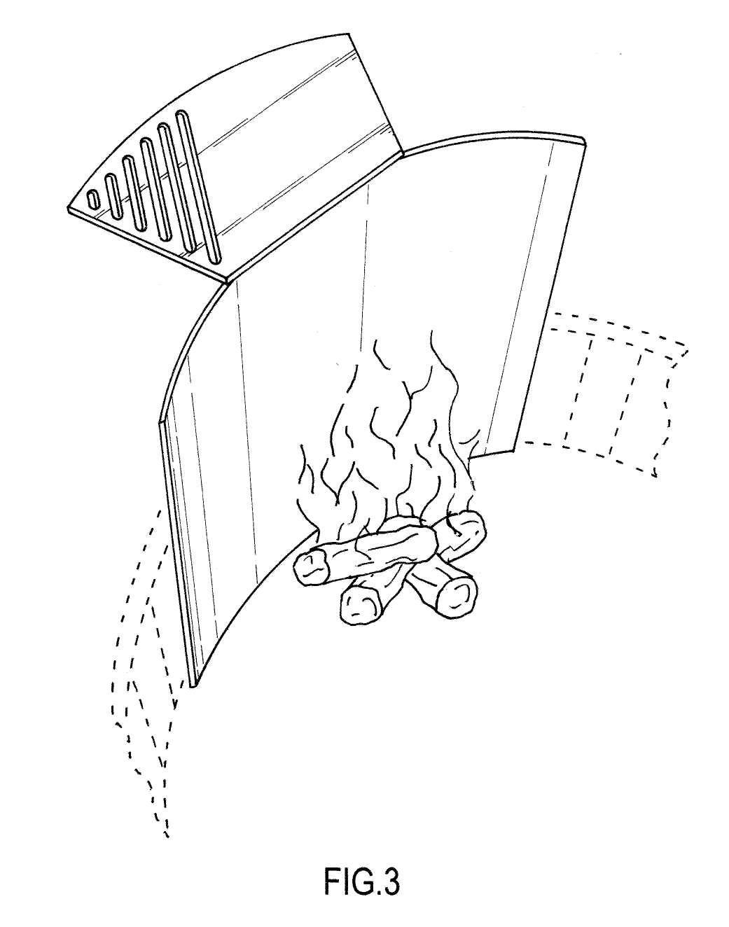

FIG. 3 is a side perspective view of a preferred embodiment of the inventive apparatus in use with a standard log fire. The support element 12 is positioned such that the inside surface 26 of the support element 12 is positioned immediately adjacent to the fire. Heat from the fire radiating against the inside surface 26 of the support element 12 is conducted upward toward the warming tray element 14 and radiates outward from the support element toward the outside edge 28 of the warming tray element 14. The connection between the support element 12 and the warming tray element 14 may allow heat to move from the support element to the warming tray element. Alternatively, in embodiments including a lip 36 extending over the fire, the fire heats the lip and the heat radiates from the lip toward the outside edge 28 of the tray. In preferred embodiments, as shown in FIGS. 1, 2A, 2B, and 3, heat radiates from the support element and the lip toward the outside edge 28 of the warming tray element. One will note that the size of the support element relative to the fire ring is variable. Alternative configurations of the support element would include a support element that extends to or a few inches above the top of the ring thus reducing the distance in which the adjacent fire heat must be conducted to the warming tray element 14. The size of the fire, in addition, is variable, and the size of the support element depends largely on the preferences of the user with regard to protection from the fire heat as well as the desire of the user to view or have immediate access to the fire over the warming tray. Further, the thickness of the support element is variable and depends, in large part, on the materials used (steel vs. copper or other conductive material for example) as well as the intended mobility of the invention (in terms of weight). FIG. 3 is provided to show an example of how the invention may be used with a standard fire ring and is not meant to be limiting with respect to size and relative dimensions of the invention, fire and ring.

Alternative configurations of the warming tray element 14 provide for differing degrees of conducted heat toward the outside edge of the warming tray. For example, embodiments having openings 38 will have a lesser degree of heat conducted toward the outside edge where those openings 38 are located. In alternative embodiments, different materials may be used either in the support element, the warming tray element, the connection between the support element and warming tray element (or all of the above) to control the conduction of heat at different locations along the warming tray element where food may be placed to warm. For example, different materials or may be used with different levels of heat conductive capacity may be used to create a warming tray which has different heat conduction to the different locations along the tray. Alternatively, different thicknesses of the same material may be used along the warming tray or support elements to control the conduction of heat.

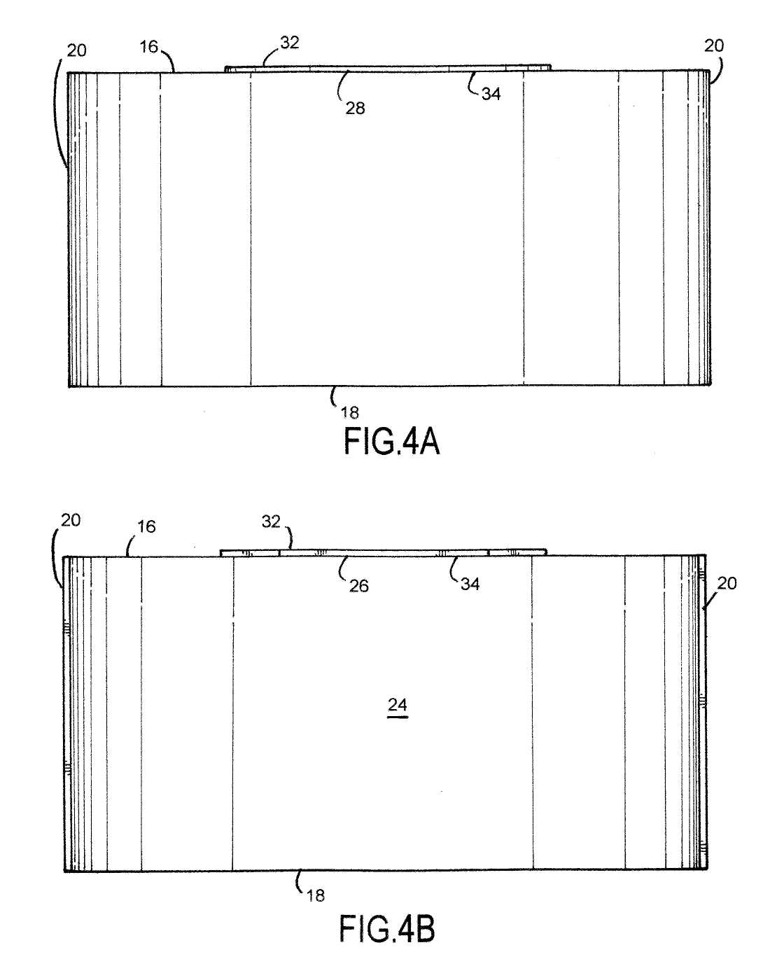

FIG. 4A and FIG. 4B are front and back views respectively of the embodiment of the food warming apparatus 10 shown in FIGS. 1, 2A, 2B, and 3. FIG. 4a shows the convex outside surface 24 of the support element 12 and the outside edge 28 of the warming tray element 14. FIG. 4B shows the concave inside surface of the support element 12 and the inside edge 26 of the warming tray 14 element. With regard to the general shape of the support element 12, that numerous alternative shapes are possible. While the preferred embodiment of the support element 12 has a top edge 16 which is of the same length as the bottom edge 18, one alternative shape would have a top edge 16 be the same length as the inside edge 26 of the warming tray 14 and the bottom edge 18 be of the same length as that of the preferred embodiment. The side edges 20 of the support element would then slant or curve inward as they extend from the bottom edge to the top edge. The importance of maintaining a longer bottom edge is in providing adequate stability to the apparatus. While it is possible to bury the bottom edge in dirt or otherwise support the support element with a fire circle, rocks or other elements to help keep it upright, the curved shape of the support element provides enough stability to allow the apparatus to place upright without feet, support legs or the like. Alternative embodiments which have shorter length of the bottom support edge 18 may incorporate support legs or feet to help keep the apparatus upright. However, generally speaking, the shorter the bottom edge 18 is, the less surface area the support element has and the less conductive material is placed directly adjacent to the fire (or other heat source) making the apparatus less efficient in absorbing heat and directing it upward to the heating tray element 14.

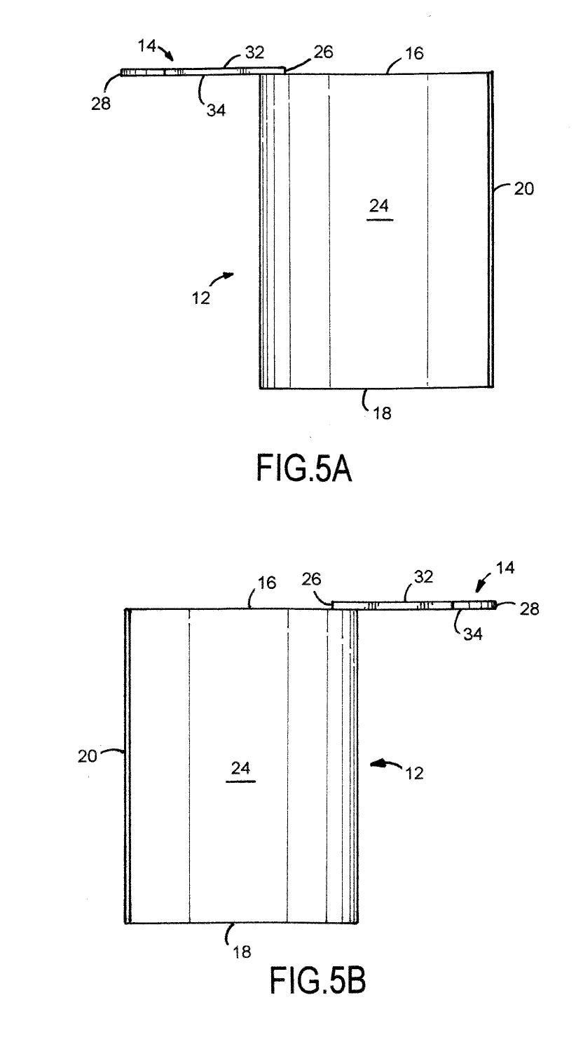

FIGS. 5A and 5B are side views of a preferred embodiment of the food warming apparatus 10 shown in FIGS. 1, 2A, 2B, 3, 4A, and 4B. The outside surface 24 of the support element is depicted as well as the side edges 30 of the warming tray 14 element. One will note that in this preferred embodiment, the inside edge 26 extend inward from the top edge of the support element toward the concave inside surface of the of the warming tray element creating a lip which extends toward the fire positioned adjacent to the inside surface 22 of the support element 12. The majority of the warming tray element 14 extends outward and away from the outside surface 24 of the support element 12. The configuration of the preferred embodiment thus relies on the conduction of heat from the inside surface of the support element up to the tray in order to heat food items placed on the top surface of the warming tray element. The lip 36 provides a limited extension of the inside edge 26 of the tray out over the fire (or other heat source) positioned below and, therefore, the lip 36 is heated somewhat by the fire and the heat is conducted outward toward the outside edge of the tray 28. In alternative embodiments, the warming tray may be connected with the support element at a position which is below the top edge 16 of the support element (thus positioning the warming tray closer to the fire) and/or the inside edge 26 of the warming tray 14 may extend further out over the fire. In this way, the apparatus relies less on the heat conducted through the support element 12. In such embodiments, it may be possible to rely solely on the warming tray element 14 to conduct heat out toward the food items placed on the top surface 32 of the tray.

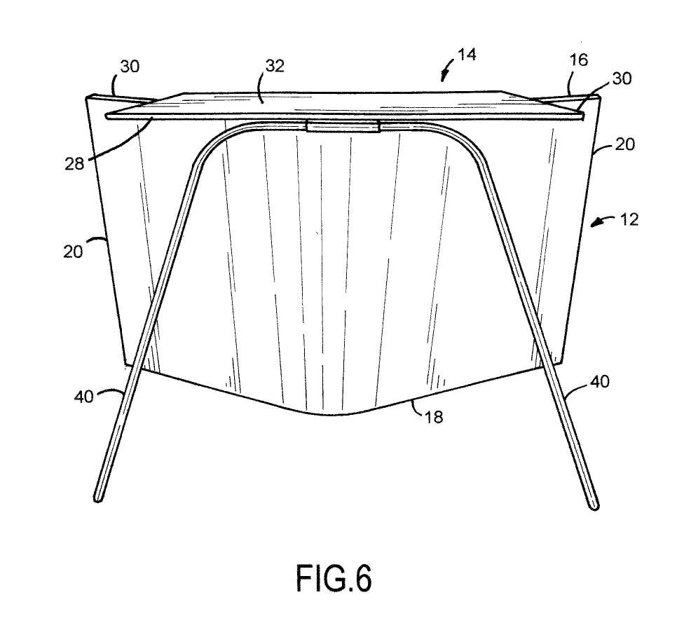

An alternative embodiment of the invention is described and shown in FIGS. 6-10. The embodiment depicted has foldable support legs 40 which are connected with the bottom surface 34 of the warming tray 14 utilizing a hinge 42. FIG. 6, for example, shows a front perspective view of an alternative embodiment of the apparatus in upright position. One will note that the warming tray element 14 is substantially rectangular in that the outside edge 28 is the same length as the inside edge 26 and the two side edges 30 are of approximately the same length. In other alternative embodiments, the warming tray element could be almost any shape, including but not limited to a circle, oval, trapezoid, rectangle, square, star or other shape as long as there is a substantially flat top surface upon which to place food items to be warmed. One will also note that the support legs 40 of the alternative embodiment shown in FIG. 6 extend downward and angle outward from the bottom surface 34 of the warming tray 14 and that the legs 40 are solid. In other alternative embodiments, the support legs may extend from the outside and/or inside surface of the support element 12. In other alternative embodiments, the support legs may be extendable (such as telescoping). In other alternative embodiments, the support legs 40 may extend downward from other positions on the bottom surface or edges of the warming tray element. In still other embodiments, the support legs 40 may be removable.

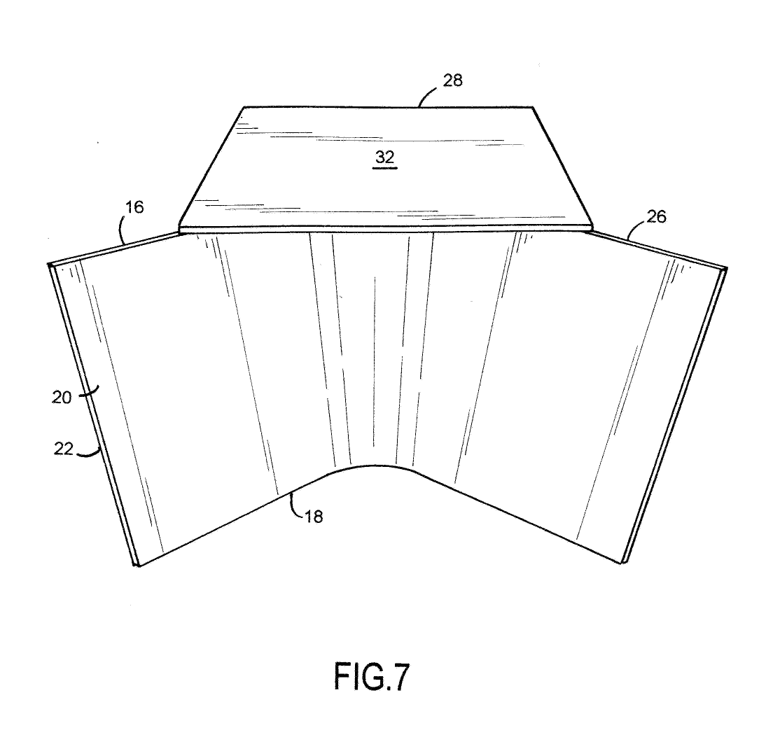

FIG. 7 shows a back side perspective view of the alternative embodiment of the food warming apparatus depicted in FIG. 6. One will note that the support element 12 has a substantially V shape relative to the uniformly curved shape of the preferred embodiment shown in FIGS. 1-5. In alternative embodiments (particularly those having support legs) the support element may be substantially flat or even cylindrical for example. The purpose of the support element is to support the warming tray at a height which is conducive for easy placement and removal of a food items (for example, to place a mug or container of coffee, a sandwich or other food item to be warmed on the warming tray element). Another purpose for the support element is to support the warming tray element relatively adjacent to an open fire. Another purpose of the support element is to conduct heat upward toward the warming tray element. Another possible purpose of the support element is to provide a barrier or shield from the fire. Another possible purpose of the support element is to provide radiating heat to persons positioned on the outside surface of the support element. Another purpose of the support element is to provide a shield from wind or to otherwise contain the fire such that persons sitting close to the warming apparatus will feel the heat radiating through the apparatus rather than the open flame.

One may also note that the alternative embodiment of the warming tray element depicted in FIG. 7 has a lip 36 which extends further away from the inside surface 22 of the support element than that of the preferred embodiment shown in FIGS. 1-6. This extending lip 36 provides additional exposure of the warming tray over the fire and, for that reason, the inside edge of the warming tray is likely to heat up more quickly than and conduct heat outward toward the outside edge. In other alternative embodiments, the inside edge of the warming tray may provide no lip at all and, in other words, may terminate at the top edge of the support element. In other alternative embodiments, the inside edge of the warming tray element may be curved (either outward or inward), may be hinged, or may be extendable or removable.

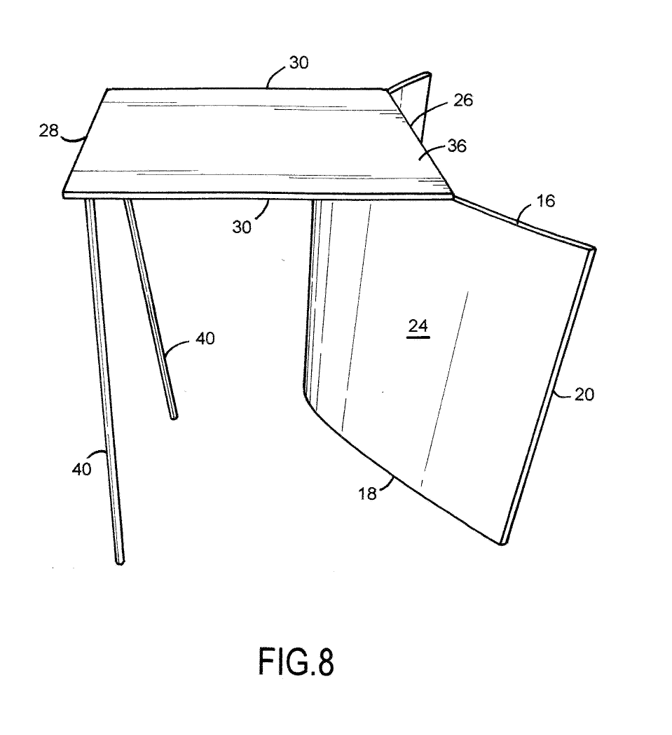

FIG. 8 is a side perspective view of the alternative embodiment of the food warming apparatus depicted in FIGS. 6-7. One will note that the embodiment of the warming tray element does not have holes to dissipate heat or vary the amount of heat reaching items placed thereon (as in the preferred embodiment depicted by FIGS. 1-5). In other alternative embodiments, a portion or the entire surface of the warming tray element may have regular holes, irregular holes, grates, mesh, and/or varying materials or material thicknesses which work to vary the amount of heat reaching different portions of the warming tray. Such alternatives allow for the user to place food items at different locations on the warming tray element depending on the amount of heat desired to reach the food item. For example, a person using the food warming apparatus with an open fire may wish to warm s'mores on one section of the warming tray and place a coffee cup on another. Variations in the heat conducted to different areas of the warming tray make the warming tray more versatile and such versatility is especially helpful considering that it is generally difficult or time consuming to vary the temperature of the warming tray once enough heat has radiated upward from the fire.

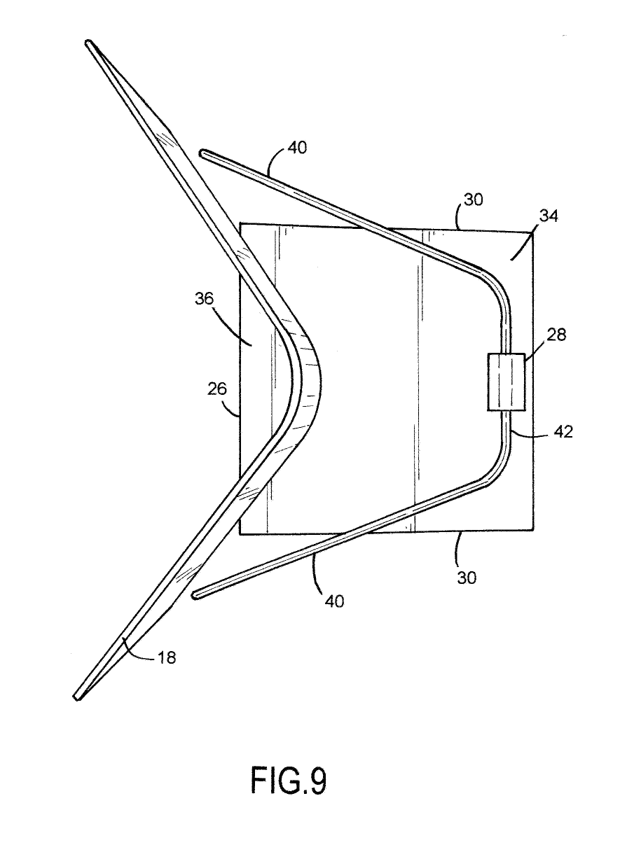

FIG. 9 is a bottom perspective view of the alternative embodiment of the food warming apparatus depicted in FIGS. 6-8. It shows that the foldable support legs 40 are connected with the bottom surface 34 of the warming tray element 14 using a hinge 42 that allows the support legs 40 to fold upward toward the warming tray element for purposes of easy storage or use when support legs are not needed or desirable. In other alternative embodiments, the support legs may be detachable and re-attachable.

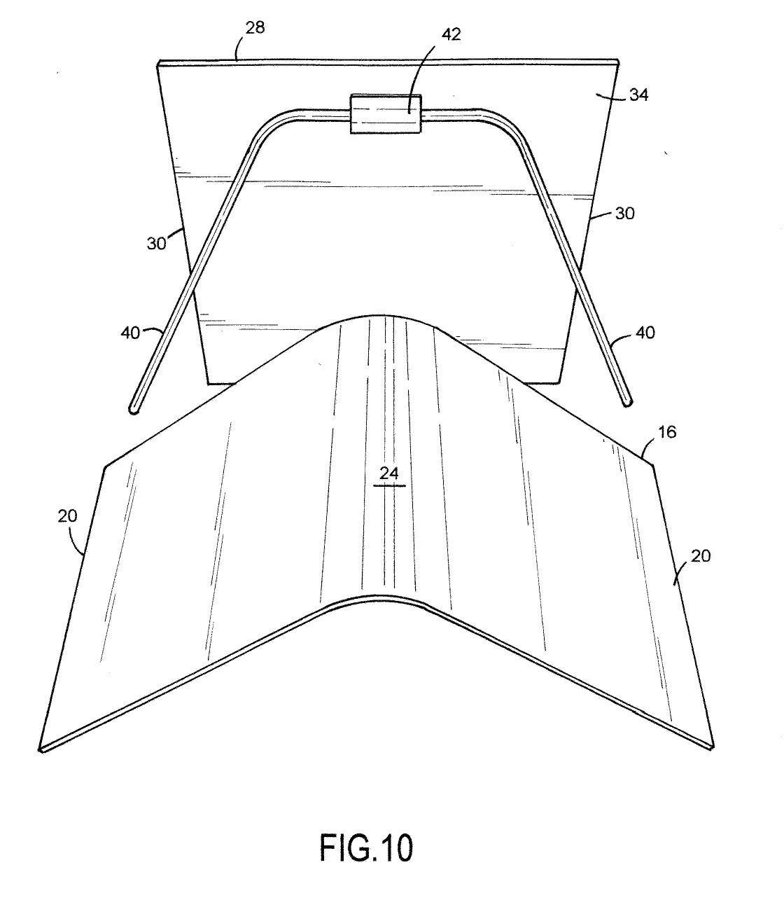

FIG. 10 is another bottom perspective view of the alternative embodiment of the food warming apparatus depicted in FIGS. 6-9. It shows that the warming tray element of this embodiment is connected with the top edge of the support element using a welded joint. A welded joint is particularly effective for making sure the connection is strong and for allowing conducted heat to move from the support element to the warming tray element during use. As previously described, there are a number of other methods in which the warming tray may be connected with the support element including hinge, mechanical means such as bolting, hooks and openings, use of joints consisting of like materials. In another alternative embodiment, the warming tray slips into an elongated slot in the support element which allows the warming tray element to be adjusted within the slot to accommodate different lengths of the warming tray extending in either direction (i.e. extending away from the inside surface or outside surface) of the support element. Such temporary connection arrangement also allows the warming tray to be removed from the support element and or different sized or shaped warming trays to be used depending on preference and/or desired utility.

In other alternative embodiments, not shown, the support element may have a flange (and or feet) connected at or near the bottom edge to assist in maintaining stability of the apparatus when in use.

Functions, operations, components and/or features described herein with reference to one or more embodiments may be combined with, or may be utilized in combination with, one or more other functions, operations, components and/or features described herein with reference to one or more other embodiments, or vice versa.

While certain features of some embodiments have been illustrated and described herein, many modification, substitutions, changes, and equivalents may occur to those skilled in the art. Accordingly, the following claims are intended to cover such modifications, substitutions, changes, and equivalents.

1. A food warming apparatus adapted for positioning with an open fire comprising:
a substantially vertical heat conductive support element having a bottom edge, a top edge, side edges, an inside surface and an outside surface,
the support element being adapted for positioning such that the inside surface is directly adjacent to an open fire,
the support element being connected with
a substantially horizontal heat conductive warming tray element having an inside edge, an outside edge, side edges, a top surface and a bottom surface,
the warming tray element being made of a heat conductive material which serves to conduct heat from its connection with the support element toward the warming tray outside edge,
the warming tray element being adapted to vary the amount of heat reaching the food items depending on the location of the food items placed thereon.

2. The food warming apparatus of claim 1, wherein a portion of the warming tray element includes openings.

3. The food warming apparatus of claim 1, wherein a portion of the warming tray element includes grates.

4. The food warming apparatus of claim 1 wherein the warming tray element is adapted to be folded for storage.

5. The food warming apparatus of claim 1 further comprising one or more supports connected with the support element for stabilizing the apparatus when in use.

6. The food warming apparatus of claim 1 further comprising one or more supports connected with the warming tray element for stabilizing the apparatus when in use.

7. The food warming apparatus of claim 5 wherein the one or more supports may be folded.

8. The food warming apparatus of claim 6 wherein the one or more support may be folded.

9. The food warming apparatus of claim 4 wherein the table element is connected with the base element by a hinge.

10. The food warming apparatus of claim 5 wherein the supports are removable.

11. The food warming apparatus of claim 6 wherein the supports are removable.

12. The food warming apparatus of claim 5 wherein the supports are adjustably extendable.

13. The food warming apparatus of claim 6 wherein the supports are adjustably extendable.

14. The food warming apparatus of claim 1 wherein the warming tray element is adjustably extendable.

15. The food warming apparatus of claim 1 wherein the support element is adjustably extendable

16. The food warming apparatus of claim 1 wherein the support element and warming tray element are made of a conductive metal material.

17. The food warming apparatus of claim 1 wherein the warming tray element is connected with the top edge of the support element.

18. The food warming apparatus of claim 1 wherein the warming tray element is connected with the support element below the top edge of the support element

19. The food warming apparatus of claim 1 wherein a portion of the warming tray element is made of non-heat-conductive material.

20. The food warming apparatus of claim 1 wherein a portion of the warming tray element extends outward from the inside surface of the support element.
